(19) United States
(12) Patent Application Publication
(10) Pub. No.: US 2025/0301226 A1
(43) Pub. Date: Sep. 25, 2025

(54) METHOD AND SYSTEM FOR PARTIALLY MAGNIFYING IMAGE AND NON-TRANSITORY COMPUTER READABLE MEDIUM

(71) Applicant: AVer Information Inc., New Taipei City (TW)

(72) Inventors: Jiunkai PENG, New Taipei City (TW); Cheng-Mou TSAI, New Taipei City (TW); Jhan-Jhang LIAO, New Taipei City (TW)

(21) Appl. No.: 19/086,152

(22) Filed: Mar. 21, 2025

(30) Foreign Application Priority Data
Mar. 21, 2024 (TW) 113110632

(51) Int. Cl. H04N 23/69; G06T 3/4053; H04N 23/60; H04N 23/61

(52) U.S. Cl. CPC H04N 23/69; G06T 3/4053; H04N 23/61; H04N 23/64

(57) ABSTRACT

A method for partially magnifying an image includes steps as follows. A target area is selected in the first image, where the target area includes at least one feature point; the specified optical zoom is adjusted according to the position of the target area in the first image, so that the target area is completely displayed in the second image; the corresponding position of the at least one feature point in the second image is determined; based on the corresponding position of at least one feature point in the second image, an image corresponding to the target area is captured from the second image.

### CROSS-REFERENCE TO RELATED APPLICATION

This application claims priority to Taiwan Application Serial Number 113110632, filed Mar. 21, 2024, which is herein incorporated by reference.

### BACKGROUND

### Field of Invention

The present invention relates to electronic devices and operation methods, and more particularly, systems and methods for partially magnifying images.

### Description of Related Art

A document camera (also called a document projector) is a special camera that can display objects (mostly physical documents and images) placed on a specific table in real time on the screen.

When manually performing PTZ (pan-tilt-zoom) operations of the document camera, this camera must first be zoomed in to a specific magnification based on experience, and then the pan/tilt is manually adjusted to the desired position step by step. The steps of the PTZ operation are cumbersome, and usually multiple pan/tilt operations are required to achieve the desired result.

In view of the foregoing, there still exist some problems on the cumbersome manual operation that await further improvement. However, those skilled in the art sought vainly for a solution. Accordingly, there is an urgent need in the related field to automatically and efficiently partially magnify images.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides systems and methods for partially magnifying images, to solve or circumvent aforesaid problems and disadvantages in the related art.

Some embodiments of the present disclosure is related to a method for partially magnifying an image includes steps of: selecting a target area in the first image, wherein the target area comprising at least one feature point; adjusting a specified optical zoom according to a position of the target area in the first image, so that the target area is completely displayed in a second image; determining a corresponding position of the at least one feature point in the second image; and capturing the image corresponding to the target area from the second image based on the corresponding position of at least one feature point in the second image.

Some embodiments of the present disclosure is related to a system for partially magnifying an image includes a camera device and a computer device, and the computer device is electrically connected to the camera device. The camera device is configured to obtain an initial image. The computer device is configured to select a target area in an initial image and to adjust an optical zoom of the camera device, so that the target area is completely presented in a magnified image obtained by the camera device based on the optical zoom, and the computer device is configured to determine a corresponding position of the at least one feature point in the target area in the magnified image and captures the image corresponding to the target area from the magnified image.

Some embodiments of the present disclosure is related to a non-transitory computer readable medium to store a plurality of instructions for commanding a computer to execute a method for partially magnifying an image, and the a method for partially magnifying the image includes steps of: selecting a target area in the first image, wherein the target area comprising at least one feature point; adjusting a specified optical zoom according to a position of the target area in the first image, so that the target area is completely displayed in a second image; determining a corresponding position of the at least one feature point in the second image; and capturing the image corresponding to the target area from the second image based on the corresponding position of at least one feature point in the second image.

In view of the above, with the system and the method for partially magnifying the image of the present disclosure, a convenient and automatic PTZ method is provided, and a better display effect of partially magnifying the image can be achieved.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a system for partially magnifying an image according to some embodiments of the present disclosure;

FIG. 2 is a flow chart of a method for partially magnifying an image according to some embodiments of the present disclosure; and

FIGS. 3-8 are schematic diagrams of the method for partially magnifying the image according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

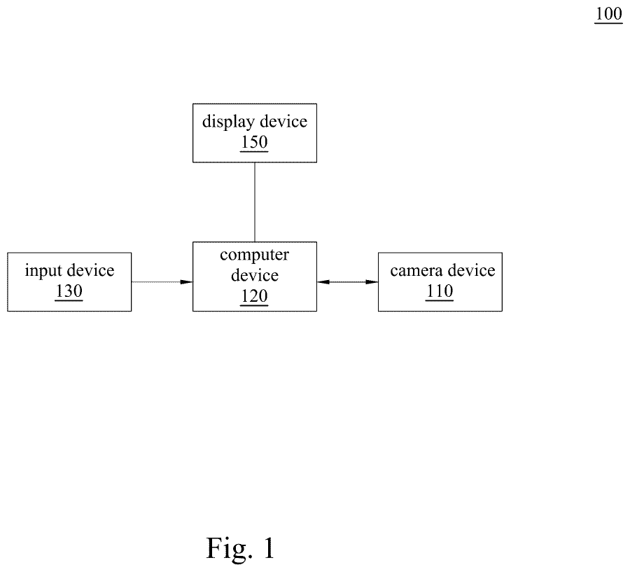

FIG. 1 is a block diagram of a system 100 for partially magnifying an image 100 according to some embodiments of the present disclosure. As shown in FIG. 1, the system 100 for partially magnifying the image can include a camera device 110, a computer device 120, an input device 130 and a display device 150. In structure, the camera device 110, the input device 130 and the display device 150 are electrically connected to the computer device 120.

In practice, for example, the computer device 120 can be a personal computer, a laptop computer, a tablet computer, a smart phone or other computer circuits. The camera device 110 can be a physical camera, a physical projector, a webcam or other camera hardware. The input device 130 can be a mouse, a keyboard, a touch device or other human-computer input interface hardware. The display device 150 can be a display screen, a monitor or other display hardware.

In use, the camera device 110 obtains an initial image. The computer device 120 selects a target area in an initial image and adjusts an optical zoom of the camera device 110, so that the target area can be completely presented in a magnified image obtained by the camera device 110 based on the optical zoom. The computer device 120 determines a corresponding position of the at least one feature point in the target area in the magnified image and captures the image corresponding to the target area from the magnified image. For example, the feature point can be a point where the grayscale value of the image changes dramatically or a point with a large curvature on the edge of the image (i.e., the intersection of two edges). The display device 150 can display the image corresponding to the target area. Thus, the system 100 for partially magnifying the image provides a PTZ method that facilitates automated operations and can achieve a better display effect of partially magnifying the image.

Regarding the selection of the target area, in some embodiments of the present disclosure, the user can input a selection command through the input device 130, and the computer device 120 performing a box selection on the target area according to the selection command input by the input device 130. Alternatively, the computer device 120 detects the target area based on the object recognition. Any of the box selection or the object recognition is more convenient than the traditionally manual PTZ method.

Regarding the specific mechanism for determining the corresponding position of the feature point in the target area in the magnified image, in some embodiments of the present disclosure, the computer device 120 detects a plurality of matching feature points in the magnified image based on a plurality of feature points in the target area of the initial image, where the plurality of the matching feature points in the magnified image match the plurality of the feature points, and the computer device 120 calculates corresponding coordinates and size of the target area in the magnified image based on coordinate changes from the feature points to the matching feature points so as to crop the image corresponding to the target area from the magnified image accordingly. Thus, the system 100 for partially magnifying the image uses the feature matching to find the target area, thereby performing more accurately partial magnification.

Alternatively, regarding the specific mechanism for determining the corresponding position of the feature point in the target area in the magnified image, in some embodiments of the present disclosure, the computer device 120 calculates corresponding coordinates of the target area in the magnified image based on the optical zoom, and the computer device 120 obtains positions of the coordinates of a plurality of vertices from the corresponding coordinates of the target area in the magnified image so as to crop the image corresponding to the target area from the magnified image accordingly. Thus, the system 100 for partially magnifying the image directly performs the coordinate transformation, which can save computing resources.

After capturing the image corresponding to the target area from the magnified image, in some embodiments of the present disclosure, the computer device 120 performs the image processing on the image of the target area. The image processing can include, for example, at least one of a super-resolution and an auto spotlight. In practice, for example, the computer device 120 enhances the details of the image by using the super resolution, or the computer device 120 highlights the object in the image by using the auto spotlight. Thus, the system 100 for partially magnifying the image is able to enhance the details of the image and the display quality.

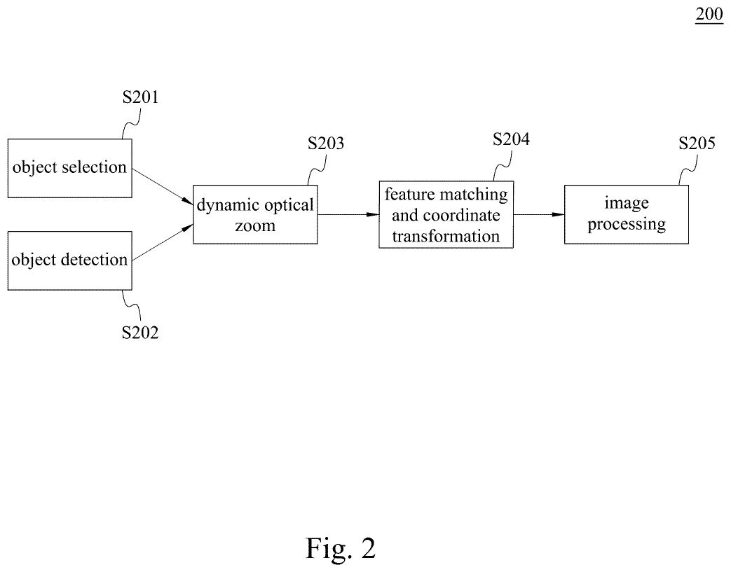

For a more complete understanding of an operation method of the system 100 for partially magnifying the image, referring FIG. 1 and FIG. 2, FIG. 2 is a flow chart of a method 200 for partially magnifying the image according to an embodiment of the present disclosure. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The method 200 for partially magnifying the image may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In steps S201 and S202, the target area is selected in the first image. In practice, for example, the first image can be the initial image obtained by the camera device 110.

Specifically, regarding the above-mentioned selection of the target area, in some embodiments of the present disclosure, in step S201, the target area is selected. Alternatively, in step S202, the target area is detected based on the object recognition. In practice, for example, the user may directly circle the area for magnification through the input device 130 (e.g., a mouse); or, after the computer device 120 detects the object through the object recognition, the user can directly click the object to be magnified through the input device 130.

In step S203, the specified optical zoom is adjusted according to the position of the target area in the first image so that the target area can be completely displayed in the second image. In some embodiments of the present disclosure, the computer device 120 finds out a suitable optical zoom according to the coordinates of the designated area and controls the camera device 110 to execute the optical zoom to obtain the second image (e.g., the magnified image). In practice, for example, when it is closer to the center of the image, the optical zoom is greater with the better image magnification effect. Thus, the method 200 for partially magnifying the image can dynamically determine the optical zoom of the camera device 110, so that the image can be partially magnified more clearly.

In step S204, the corresponding position of the feature point included in the target area in the second image is determined. Specifically, regarding the feature matching of step S204, in some embodiments of the present disclosure, the at least one feature point in the second image is detected, the at least one feature point in the first image are matched with the at least one feature point in the second image, and a corresponding coordinate in the second image in correspondence with the at least one feature point in the first image is calculated, so as to determine the corresponding position of the feature point included in the target area in the second image.

Furthermore, in step S204, the image corresponding to the target area is captured from the second image based on the corresponding position of the feature point in the second image.

Then, in step S205, an image processing is performed on the image of the target area, where the image processing includes a super resolution and an auto spotlight.

Regarding the super resolution, in practice, for example, the computer device 120 uses a single or multiple low-resolution images to generate a high-resolution image with high quality and rich detail information through machine learning or image reconstruction methods, thereby enhancing the details of the original image.

Regarding the auto spotlight, in practice, for example, the computer device 120 identifies the object in the image through the object recognition, grays out the rest of the image, and retains the image of the identified object to reduce interference from other objects in the image.

On the other hand, in some embodiments of the present disclosure, before or after step S205, optionally, the method 200 for partially magnifying the image can digitally magnify the image of the target area for the convenience of viewing by the user.

For a more complete understanding of the method 200 for partially magnifying the image, referring FIGS. 1-8, FIGS. 3-8 are schematic diagrams of the method for partially magnifying the image according to some embodiments of the present disclosure.

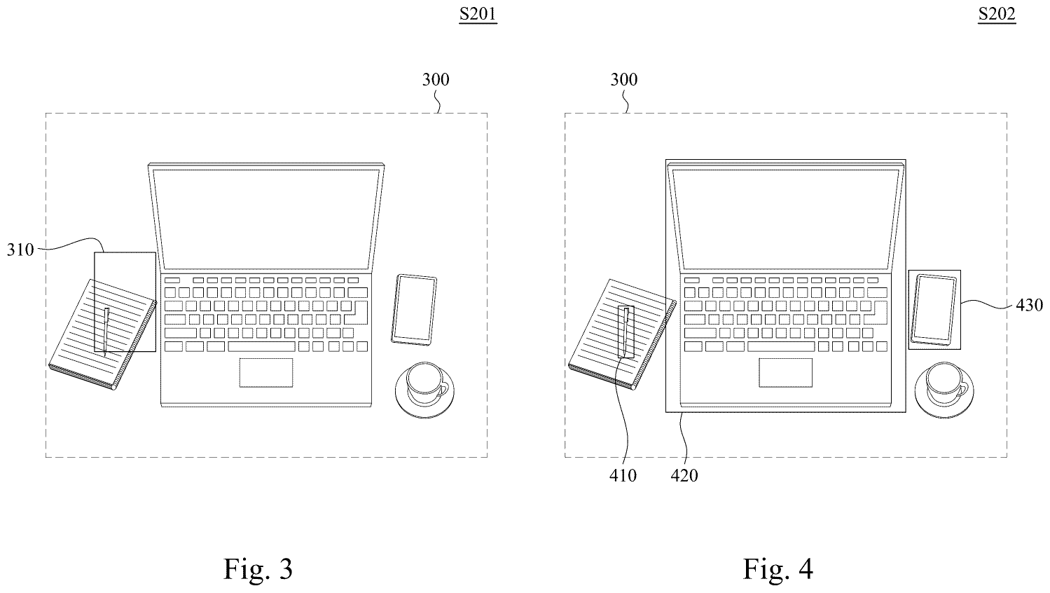

As shown in FIG. 3, in step S201, the user can input the selection command through the input device 130 (e.g., circling the area for magnification by using the mouse), and the computer device 120 selects the target area 310 in the first image 300 according to the selection command input by the input device 130. The display device 150 can display the first image 300 and the target area 310 that has been selected.

On the other hand, as shown in FIG. 4, in step S202, the computer device 120 analyzes important elements or features in the image through the image processing technology in deep learning applications, automatically identifies the objects 410, 420 and 430 in the image, and marks them for the user to select. The display device 150 can display the first image 300 and the marked objects 410, 420 and 430. The user can directly click the object(s) for magnification through the input device 130.

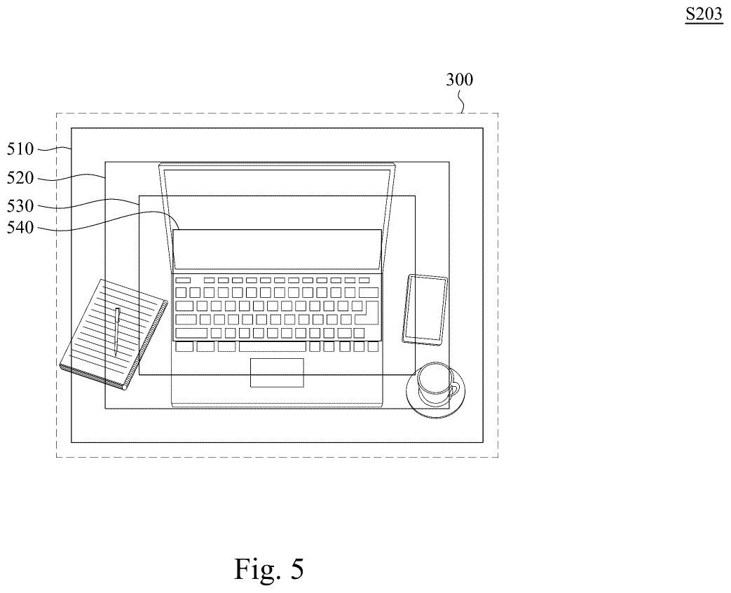

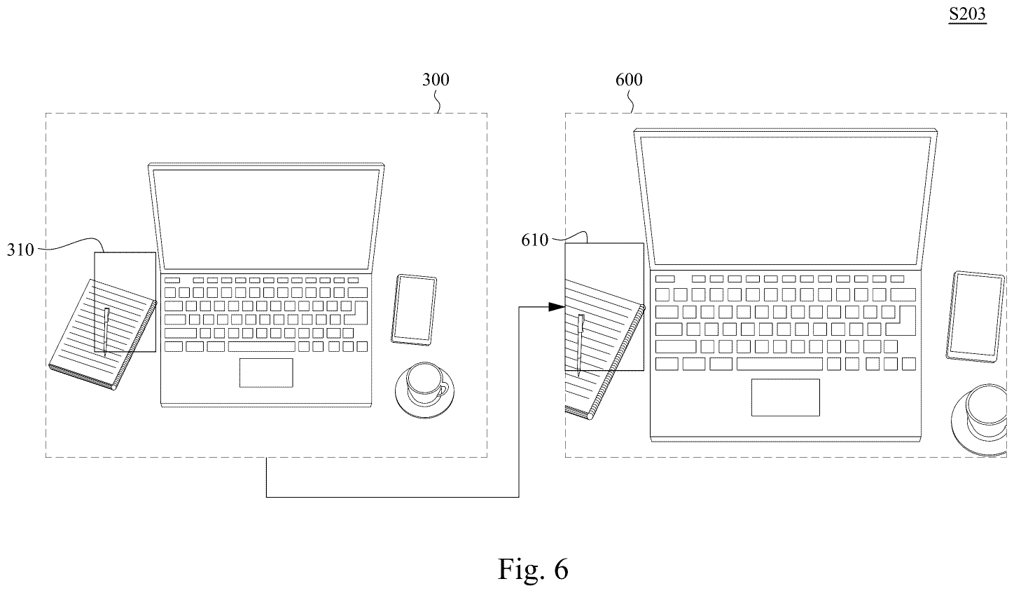

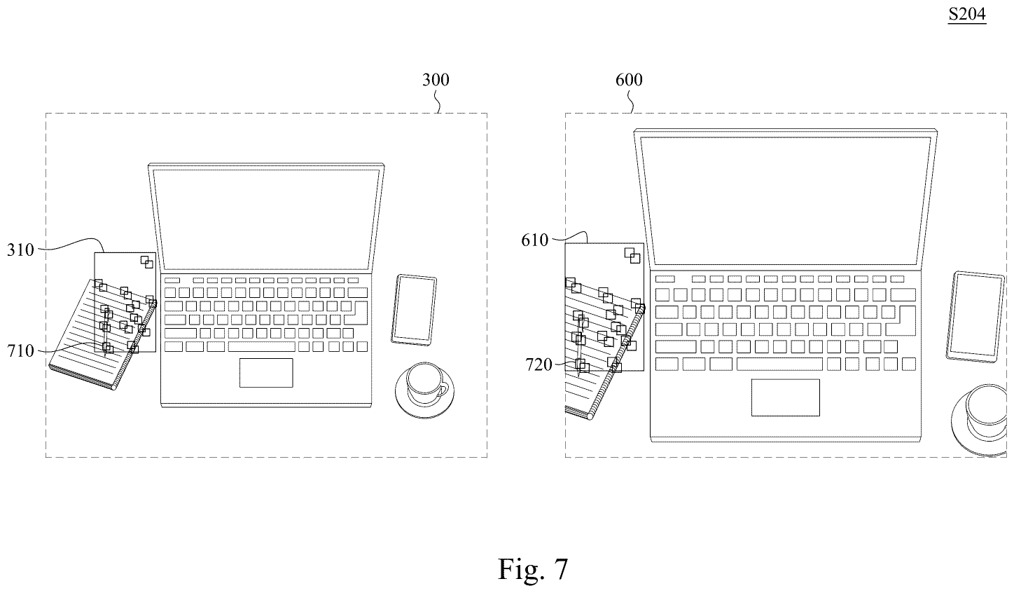

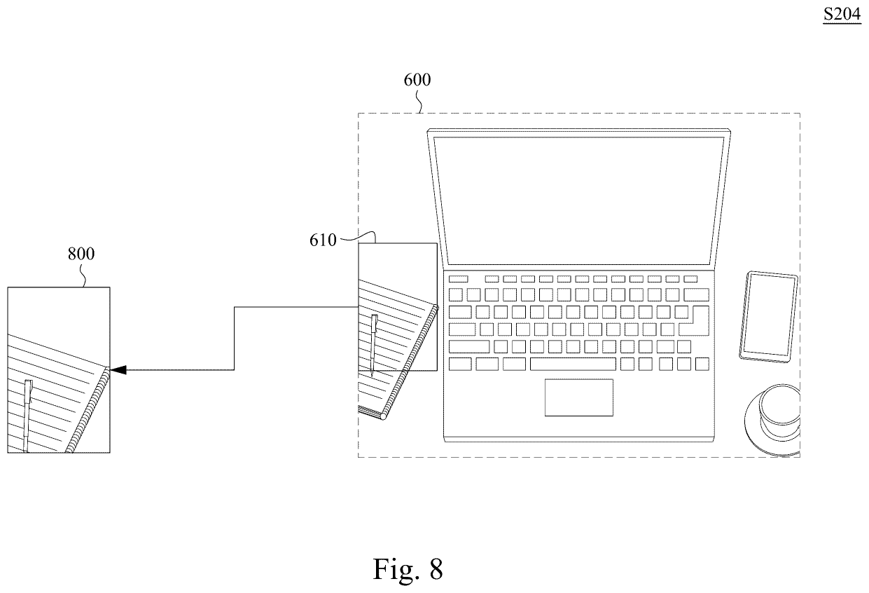

To simplify the description, the following will use the first image 300 and the target area 310 in FIG. 3 as a basis of explaining step S203 in FIGS. 5 and 6 and step S204 in FIGS. 7 and 8.

For example, if the camera device 110 is a single lens and the position of the camera device 110 does not move, as shown in FIG. 5, in step S203, the computer device 120 calculates the most appropriate optical zoom for the designated area according to the field of view (FOV) of the camera device 110 at different optical zooms, and controls the camera device 110 to perform optical zoom accordingly. In practice, for example, the area 510 is a visible range of 1 times optical zoom, the area 520 is a visible range of 2 times optical zoom, the area 530 is a visible range of 3 times optical zoom, and the area 540 is a visible range of 4 times optical zoom. When the designated object (e.g., the target area 310 in FIG. 3) is closer to the center of the first image 300, the optical zoom is greater.

When the object is specified to span different areas, the computer device 120 uses the lowest magnification to reduce the distortion of image magnified by the camera device 110. In practice, for example, if the laptop computer displayed in the first image 300 in FIG. 5 is used as the designated object (e.g., the target area), it spans 2-4 times the visible range, that is, the laptop computer in the first image 300 spans the areas 520, 530 and 540; however, merely a partially incomplete laptop computer can be presented in the area 530 (corresponding to a 3-times optical zoom) and in the area 540 (corresponding to a 4-times optical zoom), and the entire laptop computer can be presented in the area 520 (corresponding to a 2-times optical zoom) only, so the computer device 120 selects the lowest 2-times optical zoom from the above 2-4-times optical zooms, and accordingly sets the 2-times optical zoom for the camera device 110.

As shown in FIG. 6, in step S203, if the computer device 120 selects the relatively lowest 2-times optical zoom for the camera device 110, the camera device 110 is controlled to execute this optical zoom to obtain the second image 600, whose range roughly corresponds to the area 520 in FIG. 5.

As shown in FIG. 7, in step S204, the computer device 120 can detect the scale-invariant features of the image before and after magnification through feature matching technology, and compares these features with the magnified second image 600 to find the corresponding coordinates of the target area 310 as a basis of cropping, thereby achieving a more accurately partial magnification.

Regarding feature extraction and matching, in step S204, in some embodiments of the present disclosure, the computer device 120 executes a scale-invariant feature transform (SIFT), which is a computer vision feature extraction algorithm used to detect and describe partial features in the image. The computer device 120 executes the Fast Library for Approximate Nearest Neighbors (FLANN) technique to find relatively good matches more quickly. The computer device 120 executes FLANN to find the two most similar matching feature points for each feature point 710. If the degree of the matching relation between the matching feature point 720 and the feature point 710 is significantly higher than the degree of the matching relation between of the other matching feature point and the feature point 710, the matching feature point 720 is a valid matching feature point.

Then, in step S204, in some embodiments of the present disclosure, the computer device 120 removes outliers. In practice, for example, the computer device 120 uses a standard deviation method to filter out outliers, thereby removing misjudged matching feature points.

Then, in step S204, in some embodiments of the present disclosure, the computer device 120 crops the image according to the matching coordinates. In practice, for example, the computer device 120 is based on coordinate changes from the feature points 710 of the target area 310 to the matching feature points 720 for calculating corresponding coordinates and size of the target area 310 in the second image 600, so as to form the magnified target area 610, and to crop the image occupied by the magnified target area 610.

In brief, regarding the feature matching and cropping of the image in step S204, in some embodiments of the present disclosure, the computer device 120 detects a plurality of matching feature points 720 in the second image 600 based on a plurality of feature points 710 in the target area 310 of the first image 300, where the plurality of the matching feature points 720 in the second image 600 matches the plurality of the feature points 710. The computer device 120 calculates corresponding coordinates and size of the target area 310 in the second image 600 based on coordinate changes from the feature points 710 to the matching feature points 720, so as to crop the image (i.e., an image 800 occupied by the magnified target area 610 as shown in FIG. 8) corresponding to the target area 310 from the second image 600 accordingly.

Alternatively, in step S204, the computer device 120 can replace the above-mentioned feature matching with a coordinate transformation and can execute the coordinate transformation. In some embodiments of the present disclosure, the computer device 120 calculates corresponding coordinates of the target area 310 in the second image 600 based on the above-mentioned specified optical zoom (e.g., an optical magnification). The computer device 120 obtains positions of the coordinates of a plurality of vertices from the corresponding coordinates of the target area 310 in the second image 600. In practice, for example, the computer device 120 uses a plurality of vertices (e.g., four vertices) of the boundary range (e.g., a rectangle) of the target area 310 as the feature points, so as to crop the image (i.e., the image 800 occupied by the magnified target area 610 as shown in FIG. 8) corresponding to the target area 310 from the second image 600.

In view of the above, with the system 100 and the method 200 for partially magnifying the image of the present disclosure, a convenient and automatic PTZ method is provided, and a better display effect of partially magnifying the image can be achieved. In this way, the traditionally cumbersome manual PTZ operation is avoided, and there is no need to move the camera device 110.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for partially magnifying an image, comprising steps of:
selecting a target area in a first image, wherein the target area comprises at least one feature point;
adjusting a specified optical zoom according to a position of the target area in the first image, so that the target area is completely displayed in a second image;
determining a corresponding position of the at least one feature point in the second image; and
capturing the image corresponding to the target area from the second image based on the corresponding position of the at least one feature point in the second image.

2. The method for partially magnifying the image of claim 1, wherein the step of selecting the target area comprises:
performing a box selection on the target area or detecting the target area based on an object recognition.

3. The method for partially magnifying the image of claim 1, wherein the step of determining the corresponding position of the at least one feature point in the second image comprises:
detecting the at least one feature point in the second image;
matching the at least one feature point in the first image with the at least one feature point in the second image; and
calculating a corresponding coordinate in the second image in correspondence with the at least one feature point in the first image.

4. The method for partially magnifying the image of claim 1, further comprising:
digitally magnifying the image of the target area.

5. The method for partially magnifying the image of claim 1, further comprising:
performing an image processing on the image of the target area, wherein the image processing comprises a super resolution and an auto spotlight.

6. A system for partially magnifying an image, comprising:
a camera device configured to obtain an initial image; and
a computer device electrically connected to the camera device, the computer device configured to select a target area in the initial image and to adjust an optical zoom of the camera device, so that the target area is completely presented in a magnified image obtained by the camera device based on the optical zoom, and the computer device configured to determine a corresponding position of at least one feature point in the target area in the magnified image and captures the image corresponding to the target area from the magnified image.

7. The system for partially magnifying the image of claim 6, further comprising:
an input device electrically connected to the computer device, wherein the computer device performing a box selection on the target area according to a selection command input by the input device, or the computer device detects the target area based on an object recognition.

8. The system for partially magnifying the image of claim 6, wherein the computer device detects a plurality of matching feature points in the magnified image based on a plurality of feature points in the target area of the initial image, the plurality of the matching feature points in the magnified image matches the plurality of the feature points, and the computer device calculates corresponding coordinates and size of the target area in the magnified image based on coordinate changes from the feature points to the matching feature points so as to crop the image corresponding to the target area from the magnified image accordingly.

9. The system for partially magnifying the image of claim 6, wherein the computer device calculates corresponding coordinates of the target area in the magnified image based on the optical zoom, and the computer device obtains positions of coordinates of a plurality of vertices from the corresponding coordinates of the target area in the magnified image so as to crop the image corresponding to the target area from the magnified image accordingly.

10. The system for partially magnifying the image of claim 6, wherein the computer device performs an image processing on the image of the target area, and the image processing comprises at least one of a super resolution and an auto spotlight.

11. A non-transitory computer readable medium to store a plurality of instructions for commanding a computer to execute a method for partially magnifying an image, and the method for partially magnifying the image comprising:
selecting a target area in a first image, wherein the target area comprises at least one feature point;
adjusting a specified optical zoom according to a position of the target area in the first image, so that the target area is completely displayed in a second image;
determining a corresponding position of the at least one feature point in the second image; and
capturing the image corresponding to the target area from the second image based on the corresponding position of the at least one feature point in the second image.

12. The non-transitory computer readable medium of claim 11, wherein the step of selecting the target area comprises:
performing a box selection on the target area or detecting the target area based on an object recognition.

13. The non-transitory computer readable medium of claim 11, wherein the step of determining the corresponding position of the at least one feature point in the second image comprises:
detecting the at least one feature point in the second image;
matching the at least one feature point in the first image with the at least one feature point in the second image; and
calculating a corresponding coordinate in the second image in correspondence with the at least one feature point in the first image.

14. The non-transitory computer readable medium of claim 11, wherein the method for partially magnifying the image further comprises:
digitally magnifying the image of the target area.

15. The non-transitory computer readable medium of claim 11, wherein the method for partially magnifying the image further comprises:
performing an image processing on the image of the target area, wherein the image processing comprises a super resolution and an auto spotlight.
